(19) United States
(12) Patent Application Publication
(10) Pub. No.: US 2015/0128891 A1
(43) Pub. Date: May 14, 2015

(54) ENGINE CONTROL VALVE

(71) Applicant: Grégory Hodebourg, Sartrouville (FR)

(72) Inventor: Grégory Hodebourg, Sartrouville (FR)

(73) Assignee: Valeo Systemes de Controle Moteur, Cergy Saint Christophe (FR)

(21) Appl. No.: 14/401,147

(22) PCT Filed: Apr. 26, 2013
(86) PCT No.: PCT/FR2013/050937

§ 371 Date: Nov. 14, 2014

(30) Foreign Application Priority Data
May 15, 2012 (FR) 1254430

(51) Int. Cl. F02D 9/10; F02D 9/02

(52) U.S. Cl. CPC F02D 9/101; F02D 9/02
USPC 123/190.1

(57) ABSTRACT

An engine control valve includes a flap pivotally mounted on an axis separating the said flap into a first part and a second part that are joined together at an interface plane defining a planar shoulder, the flap being capable of occupying a closed position in order to interrupt the passage of the gases, and for which purpose the first part interacts with a first portion of a joint and the second part interacts with a second portion of this joint, the joint being integral with the internal structure of the valve. A valve is characterized mainly by the first part of the flap has an overhang that arises on the shoulder and extends parallel to the second part of the flap.

The invention relates to an engine control valve with improved sealing.

The valve can be integrated in the air supply circuit of an internal combustion engine.

In the context of the invention, the expression “air supply circuit of an internal combustion engine” is used to designate the circuit between the admission inlet and the exhaust outlet of the internal combustion engine. The valve may be arranged in the admission circuit, in the exhaust circuit, or in a recirculation loop that is traversed by the exhaust gases that are to be reinjected into the admission (EGR in English).

This type of valve may, for example, equip a gas supply circuit of an internal combustion engine of a motor vehicle, in particular for the purpose of regulating the flow of the EGR gases (from the English Exhaust Gas Recirculation) in a loop permitting the collection of a proportion of the exhaust gases as they exit from the engine, before reinjecting them into the admission circuit upstream of the said engine. The operating principle of this type of valve is based on the controlled rotation of a flap that is capable of moving from a fully open position, in order to allow the fluid to pass, to a closed position, in order to obstruct this passage. The invention has, as its object, an engine control valve with improved sealing.

An engine control valve thus possesses a flap, which is pivotably mounted on an axis of rotation in such a way that the said axis separates the flap into a first part and a second part. It should be noted here that no physical limit demarcates the boundary between the first and the second part of the flap, the said parts being notionally separated by a plane passing through the axis of rotation of the flap and intersecting the said flap perpendicularly. When this flap is in a closed position, it comes into contact with a sealing joint which is integral with the internal structure of the valve. More precisely, the first part comes into contact with one face of the joint, while the second part of the said flap preferably approaches next to the opposite face of the said joint, maintaining a little free play in order to avoid hyperstatism.

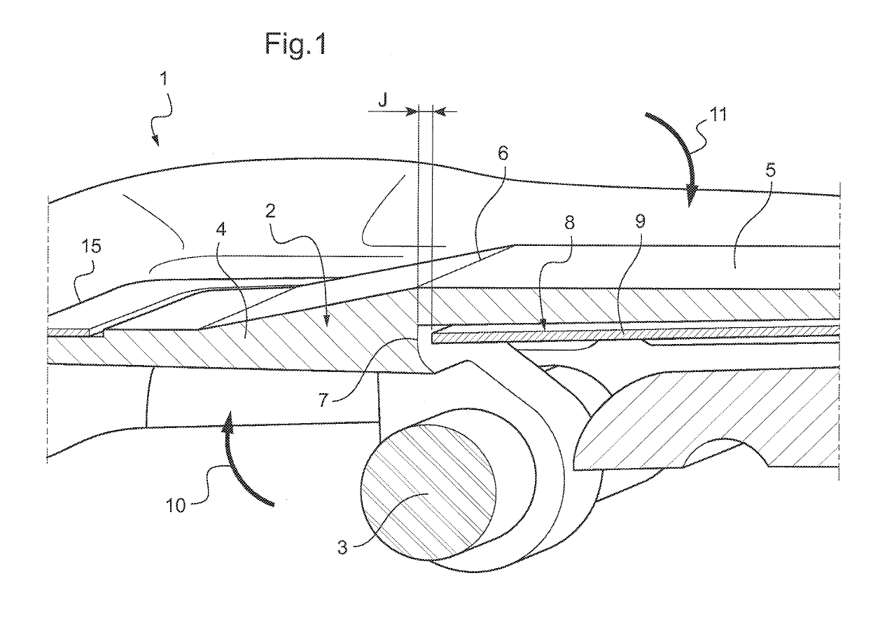

In fact, with reference to FIG. 1, a state-of-the-art engine control valve 1 comprises a flap 2 that is pivotably mounted about an axis of rotation 3 separating the said flap 2 into a first part 4 and a second part 5, the said parts 4, 5 being joined one to the other in a rigid manner and in continuation one after the other. The flap 2 has the overall form of a rectangular parallelepiped of small thickness, the longitudinal axis of which is perpendicular to the axis of rotation 3, the said axis 3 passing through the said flap 2 in an asymmetrical manner. Thus, the first part has a rectangular form, the longitudinal axis of which is parallel to the axis of rotation 3, and the second part 5 likewise has a rectangular form, the longitudinal axis of which is perpendicular to the said axis of rotation 3. The second part 5 of the flap 2 has a constant thickness, while the first part 4 exhibits different thicknesses. The thickness of the first part 4 of the flap 2 is greater than that of the second part in the said junction zone 6, so that it creates, between the said parts 4, 5, a shoulder 7, which extends between the second part 5 of the said flap 2 and the axis of rotation 3, in a plane perpendicular to the said second part 5. The joint 8 of the internal structure of the valve 1, against which the flap 2 comes to rest when the latter is in a closed position, is planar and comprises a first portion that is capable of interacting with the first part 4 of the flap 2, and a second portion 9 intended to interact with the second part 5 of the flap 2. The two portions 9 of the joint are planar and in continuation one after the other. With reference to FIG. 1, when the flap 2 pivots in order to close, the first part 4 rises in the direction indicated by the first arrow 10 in order to come into contact with the lower face of the first portion of the joint 8, while the second part 5 of the flap 2 folds back onto the upper face of the second portion 9 of the said joint 8 in the direction indicated by the second arrow 11.

A problem that is encountered from time to time with such a configuration of the flap 2 is the existence of free play J between the shoulder 7 of the said flap 2 and one extremity of the second portion 9 of the joint 8 when the flap 2 is in a closed position. This free play J provides an undesired passage for the gases and, as such, will contribute to the deterioration of the sealing of the valve.

An engine control valve according to the invention has undergone a structural modification in order to limit the effect of this free play and to increase the sealing of the valve when it is in its closed position.

The invention has as its object an engine control valve comprising a flap pivotally mounted on an axis separating the said flap into a first part and a second part that are joined together at an interface plane defining a shoulder, the said flap being capable of occupying a closed position in order to interrupt the passage of the gases, and for which purpose the first part interacts with a first portion of a joint and the second part interacts with a second portion of this joint, the said joint being integral with the internal structure of the valve. A valve according to the invention is characterized mainly in that the first part of the flap comprises an overhang that arises on the shoulder and extends parallel to the second part of the said flap. The purpose of this overhang, which extends parallel to the second part of the flap, is to occupy the free play J that is evident on the existing valves between the second portion of the joint and the shoulder marking the boundary between the first and the second part of the flap when the flap is in a closed position. This overhang is thus intended to come into contact with the second portion of the joint in order to eliminate this free play. This overhang has small dimensions in order for it to not interfere with the mechanism for opening or closing the valve.

The valve may be configured in such a way that the interaction between the flap and the joint induces a deformation of the joint, rather than a compression of the latter, contrary to the indication given in application US 2010/0148107, according to which the sealing of the valve in its closed position entails the compression of two joints with the flap. The deformation may correspond to a displacement of the whole of the portion of the joint interacting with the flap.

The portions of the joint interacting with the flap may be arranged in a cantilevered manner in relation to the internal structure of the valve. These portions may thus project into the conduit in the area of the valve.

The valve may be a three-way valve, that is to say that it permits the distribution of a fluid between three channels, for example from an inlet towards one or the other of two outlets, or from a first and/or a second inlet towards a single outlet.

The axis may be offset in relation to the flap, that is to say that planes intersecting the axis without intersecting the flap, and vice versa, exist.

Advantageously, the overhang extends over the entire width of the flap, this being its dimension measured along the axis of rotation, the said overhang providing a space together with the second part. This space permits the section portion of the joint to insert itself between the overhang and the second part of the flap when the flap is in a closed position. It is important for the overhang to extend over the entire width of the flap in such a way as to cause the free play to disappear entirely. If the overhang were to be smaller than this width, it would merely limit the free play to a more restricted zone.

Preferentially, the length of the overhang, this being its dimension measured in a direction perpendicular to the plane of the shoulder, permits an overlap of the said overhang with the second portion of the joint when the flap is in a closed position. The overhang could be dimensioned most effectively by permitting contact in the same plane with the second portion of the joint, without any overlap. This configuration, although possible, would nevertheless tend to rather randomize the disappearance of the free play because of the rather approximate contact between the said overhang and the said second portion of the joint. An overlap ensures a closer and more reliable contact between the overhang and the second portion of the joint, thereby permitting the effects of the evident free play J to be limited.

Advantageously, the contact surface between the overhang and the second portion of the joint is planar. The provision of an extended contact surface constitutes an optimized configuration in order to ensure effective sealing between the overhang and the joint.

Preferably, the length of the overhang is less than 5 millimeters. In fact, this overhang, the sole function of which is to be brought into in contact with the second portion of the joint, must be dimensioned most effectively in order to avoid placing a burden on the flap and interfering with its rotation mechanism. It should be noted that the length of the overhang is its dimension measured in a direction perpendicular to the plane of the shoulder.

According to a preferred embodiment of a valve according to the invention, the first and the second part of the flap, together with the overhang, form one and the same component. This is the simplest configuration of the flap and the one that is the most rapid, and thus the least costly, to manufacture.

Advantageously, the second portion of the joint is solid.

Preferentially, the overhang is deformable in order to improve the conditions of contact with the second portion of the joint. In fact, when the joint itself is generally also deformable, the contact between these two deformable elements will be optimized and will consequently improve the sealing conditions of the valve.

Advantageously, the cross section of the overhang is rectangular. It is assumed that the longitudinal axis of the overhang is parallel to the axis of rotation of the flap. A rectangular parallelepipedic overhang is easy to machine and is efficient compared to the stated objective, offering a planar contact surface with the second portion of the joint.

The invention has as its second object a flap for the implementation of a valve according to the invention.

The valves according to the invention exhibit the advantage of being efficient in terms of sealing, thanks to a simple structural arrangement, of being capable of rapid implementation, of having compact dimensions and of being realized on the flap. They also exhibit the advantage of offering an additional functionality as a consequence of this improved sealing, while remaining at a substantially constant cost level.

A detailed description of a preferred embodiment of a valve according to the invention is provided below with reference to the accompanying drawings, in which:

FIG. 1 is a schematic view in perspective of the flap equipping an engine control valve according to the prior art,

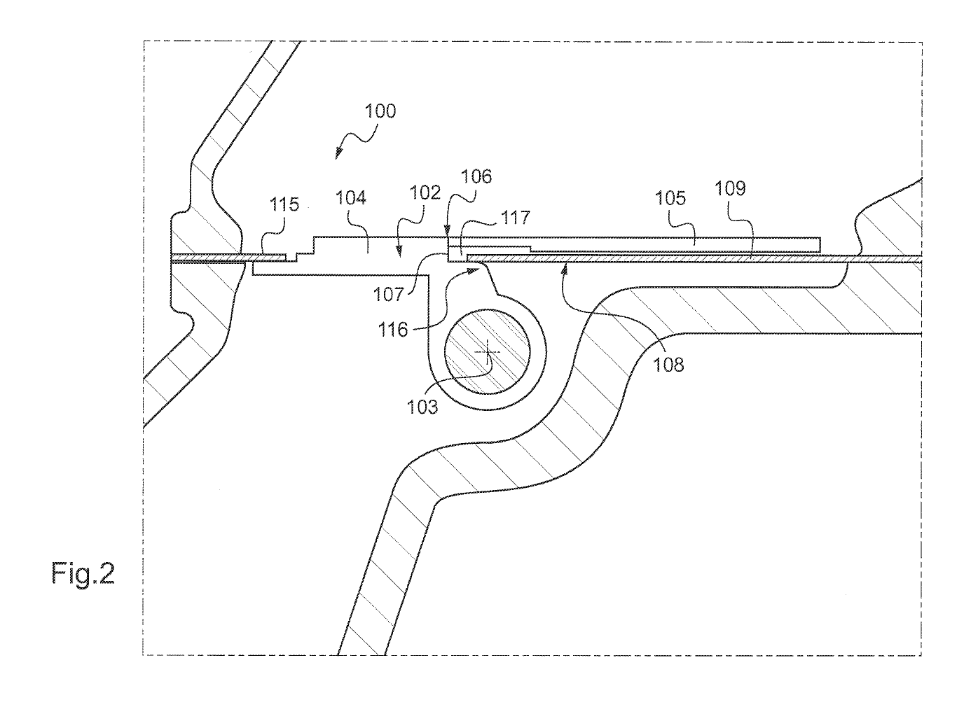

FIG. 2 is a schematic view in perspective of the flap equipping an engine control valve according to the invention.

FIG. 1 has already been described.

With reference to FIG. 2, an engine control valve 100 according to the invention comprises a flap 102 mounted pivotably about an axis of rotation 103. The flap 102 is constituted by a first part 104 and a second part 105, the said parts 104, 105 being joined one to the other in a rigid manner and in continuation one after the other. The flap 102 has an overall rectangular form, the longitudinal axis of which is perpendicular to the axis of rotation 103, the said axis 103 passing through the said flap 102 in an asymmetrical manner. Thus, the first part 104 has a rectangular form, the longitudinal axis of which is parallel to the axis of rotation 103, and the second part 105 likewise has a rectangular form, the longitudinal axis of which is perpendicular to the said axis of rotation 103. The second part 105 of the flap 102 has a constant thickness, except on the part 117, while the first part 104 exhibits a variable thickness. In fact, the thickness of the first part 104 increases progressively along the longitudinal axis of the flap 102, starting from a minimal thickness in the area of a free edge 115 of the said flap 102, before reaching a maximum value in the area of the junction zone 106 of the two parts 104, 105 of the flap 102. The thickness of the first part 104 of the flap 102 is greater than that of the second part 105 in the area of their junction zone 106, so that it creates between the said parts 104, 105 a plane shoulder 107, which extends between the second part 105 of the said flap 102 and the axis of rotation 103 in a plane perpendicular to the said second part 105. This shoulder 107 is extended by an overhang 116, measured along the axis of rotation 103, the said overhang protruding from the said shoulder 107, parallel to the said second part 105. This overhang 116 constitutes an elongated part, the longitudinal axis of which is parallel to the axis of rotation 103 of the flap 102, and the cross section of which is rectangular. This overhang 116 constitutes, for the first part 104 of the flap 102, a projecting bead providing, together with the second part 105 of the flap 102, a free space 117 of constant width. The length of the overhang 116, measured in a direction perpendicular to the plane of the shoulder 107, is less than 5 millimeters. The first part 104, the second part 105 and the overhang 116 constitute one and the same component. The joint 108 of the internal structure of the valve 100, against which the flap 102 comes to rest when the latter is in a closed position, comprises a first portion 115 that is capable of interacting with the first part 104 of the flap 102, and a second portion 109 intended to interact with the second part 105 of the flap 102. The two portions are planar and are in continuation one after the other, in order to form a planar joint 108, as a single component. The first portion of the joint 108 comprises an opening, the dimensions of which are substantially equal to the section for the passage of the gases into the valve 100. Furthermore, the second portion 109 of the joint 108 is solid.

When the flap 102 is in a closed position, the overhang 116 of the first part 104 of the flap 102 is present against the second portion 109 of the joint 108, thereby establishing surface contact with the said portion 109 and safeguarding the valve from leaks produced by the free play J in valves of the prior art between the flap 102 and the joint 108.

1. A valve for the air supply circuit of an internal combustion engine, comprising:
a flap pivotally mounted on an axis separating the said flap into a first part and a second part that are joined together at an interface plane defining a planar shoulder,
the flap being capable of occupying a closed position in order to interrupt the passage of the gases, and for which purpose the first part interacts with a first portion of a joint and the second part interacts with a second portion of the joint, the joint being integral with the internal structure of the valve,
the first part of the flap comprising an overhang that arises on the shoulder and extends parallel to the second part of the said flap.

2. The valve as claimed in claim 1, the overhang extending over the entire width of the flap, with a dimension measured along the axis of rotation, and the overhang providing a space together with the second part.

3. The valve as claimed in claim 1, wherein the length of the overhang, with a dimension measured in a direction perpendicular to the plane of the shoulder, permitting an overlap of the said overhang with the second portion of the joint when the flap is in a closed position.

4. The valve as claimed in claim 1, wherein the contact surface between the overhang and the second portion of the joint is planar.

5. The valve as claimed in claim 1, the length of the overhang being less than 5 millimeters.

6. The valve as claimed in claim 1, the first and the second part of the flap, together with the overhang, forming one and the same component.

7. The valve as claimed in claim 1, the second portion of the joint being solid.

8. The valve as claimed in claim 1, the overhang being deformable in order to improve the conditions of contact with the second portion of the joint.

9. The valve as claimed in claim 1, the cross section of the overhang being rectangular.

10. The valve as claimed in claim 1, Wherein the interaction between the flap and the joint induces a deformation of the joint, and not a compression of the latter.

11. The valve as claimed in claim 10, the portions of the joint interacting with the flap being arranged in a cantilevered manner in relation to the internal structure of the valve.

12. The valve as claimed in claim 1, wherein the valve is a three-way valve.

13. The valve as claimed in claim 1, the axis being offset in relation to the flap.
